(19) United States
(12) Patent Application Publication
(10) Pub. No.: US 2026/0241466 A1
(43) Pub. Date: Aug. 20, 2026

(54) Clamping Mandrel Adapter Device, Assembly Method for Assembling a Clamping Mandrel Adapter Device, and Machine Tool System with a Machine Tool and with a Clamping Mandrel Adapter Device

(71) Applicant: Robert Bosch GmbH, Stuttgart (DE)

(72) Inventors: Nathanael Brigger, Grenchen (CH); Donghui Ding, Zhenjiang (CN)

(21) Appl. No.: 18/852,764

(22) PCT Filed: Mar. 10, 2023
(86) PCT No.: PCT/EP2023/056158

§ 371 Date: Sep. 30, 2024

(30) Foreign Application Priority Data
Apr. 12, 2022 (DE) 10 2022 203 655.7

(51) Int. Cl. B23B 51/04

(52) U.S. Cl. CPC B23B 51/0473; B23B 51/0426

(57) ABSTRACT

A clamping mandrel adapter device for assembling a hole saw unit, which includes at least one centering drill bit and a hole saw, on a machine tool, including at least one main adapter body, which has at least one tool interface for assembling on the machine tool and at least one tool holder for receiving the hole saw unit. The clamping mandrel adapter device includes at least one circular-cylindrical receiving region for the centering drill bit, and a hollow cylindrical receiving region for the hole saw. The tool holder is in the form of a hollow cylinder with an inner lateral surface and an outer lateral surface, and delimits the at least one, in particular circular-cylindrical, receiving region for the centering drill bit with the inner lateral surface, and at least partially delimits the, in particular hollow cylindrical, receiving region for the hole saw with the outer lateral surface.

Clamping mandrel adapter device, assembly method for assembling a clamping mandrel adapter device, and machine tool system with a machine tool and with a clamping mandrel adapter device

### PRIOR ART

A clamping mandrel adapter device is proposed, for assembling a hole saw unit, which comprises at least one centering drill bit and a hole saw, on a machine tool, comprising at least one main adapter body, which has at least one tool interface for assembling on the machine tool and at least one tool holder for receiving the hole saw unit.

### DISCLOSURE OF THE INVENTION

The invention is based on a clamping mandrel adapter device for assembling a hole saw unit, which comprises at least one centering drill bit and a hole saw, on a machine tool, comprising at least one main adapter body, which has at least one tool interface for assembling on the machine tool and at least one tool holder for receiving the hole saw unit.

It is proposed that the clamping mandrel adapter device comprises at least one, in particular circular-cylindrical, receiving region for the centering drill bit, and a, in particular hollow cylindrical receiving region for the hole saw, wherein the tool holder is in the form of a hollow cylinder with an inner lateral surface and an outer lateral surface, and delimits the at least one, in particular circular-cylindrical, receiving region for the centering drill bit with the inner lateral surface, and at least partially delimits the, in particular hollow cylindrical, receiving region for the hole saw with the outer lateral surface, wherein the tool holder, in particular the entire main adapter body, is a single piece.

In this context, a clamping mandrel adapter device is to be understood in particular as an adapter which is intended to connect the hole saw unit to the machine tool in order to transmit at least one torque from the machine tool to the hole saw unit. The clamping mandrel adapter device is designed in such a way that the hole saw unit can be assembled and disassembled non-destructively and without tools. The clamping mandrel adapter device is designed for non-destructive assembly and disassembly on the machine tool. The clamping mandrel adapter device is designed in such a way that the tool interface and the tool holder have the same axis of rotation. In this context, a hole saw is to be understood in particular as a circular-cylindrical cutting tool. In particular, the hole saw is at least essentially hollow-cylindrical and delimits a cylindrical space. The hole saw is designed to produce a circular bore. In an assembled state of the hole saw unit, the centering drill bit is preferably arranged at least partially in the space delimited by the hole saw. Preferably, the centering drill bit extends through the space delimited by the hole saw. Preferably, the centering drill bit and the hole saw have a common axis of rotation when the hole saw unit is assembled. The hole saw unit is intended for use on the machine tool. The machine tool is preferably designed as a drilling machine, in particular a pillar drilling machine, a hand drill or another machine tool which appears to a skilled person to be useful and by means of which the clamping mandrel adapter device can be rotatably driven. The main adapter body is preferably designed to accommodate the hole saw unit and connect it to the machine tool. Preferably, the main adapter body is designed to transmit a rotational movement of the machine tool to the hole saw unit. Preferably, the main adapter body forms the tool interface for a connection with a tool holder of the machine tool. The tool interface is preferably polygonal. Preferably, the tool interface is hexagonal. Alternatively, it is conceivable that the tool interface is circular-cylindrical, conical or polynomial. In a circular-cylindrical design, the tool interface preferably has at least one recess for assembly and disassembly. By the fact that the tool interface is polygonal, in particular hexagonal, it should be understood in particular that at least one cross-sectional surface of the tool interface is polygonal, in particular hexagonal. Preferably, the tool interface has a polygonal, in particular hexagonal, cross-sectional area over at least 50%, preferably at least 75% and particularly preferably at least 95%, of its total extension in a main extension direction of the tool interface. A “main extension direction” of an object is understood to be a direction that runs parallel to the longest edge of a smallest geometric cuboid that just completely encloses the object. Preferably, the tool interface is intended to be received by the machine tool. Preferably, the tool interface is made from a solid material. In the case of a hexagonal design, the tool interface preferably has a groove running completely around the tool interface. The groove of the tool interface is preferably provided for a quick-change system between the clamping mandrel adapter device and the machine tool. Preferably, the groove is formed in particular by a recess for a ball detent. Preferably, the tool interface is formed by a HEX interface, particularly a standardized one. Preferably, a torque, which is intended to drive the hole saw unit, is transmitted from the machine tool to the main adapter body by means of a positive-fit connection, in particular through the hexagonal cross-section of the tool interface. The receiving region for the centering drill bit preferably has at least one opening for inserting the centering drill bit. The opening for the centering drill bit is preferably arranged on a side of the main adapter body facing away from the tool interface. The tool holder is preferably designed in such a way that the hole saw and the centering drill bit have the same axis of rotation. Preferably, the tool holder and the tool interface are connected as a single piece. Advantageously, “as a single piece” should also be understood as “integrally”. The term “integrally” should be understood in particular to mean to be formed as a single piece. Preferably, this single piece is manufactured from a single blank, a mass and/or a casting, particularly preferably in an injection molding method, especially a single and/or multi-component injection molding method.

The design of the clamping mandrel adapter device according to the invention can advantageously provide a tool holder for a hole saw and a centering drill bit with improved properties in terms of centering. The vibration of the clamping mandrel adapter device can be kept to a minimum. An advantageously long service life of the clamping mandrel adapter device can be achieved. A high cutting quality can be advantageously provided during operation of the clamping mandrel adapter device. A clamping mandrel adapter device with an advantageously fast tool change can be provided.

It is further proposed that the clamping mandrel adapter device has a quick-clamping unit with at least one quick-clamping element, which is arranged in a bore of the main adapter body, wherein the quick-clamping unit is provided for fixing and releasing the centering drill bit at least axially in the receiving region of the centering drill bit. Preferably, the quick-clamping element forms a thread for screwing into the main adapter body. Preferably, the main adapter body has the bore with a thread for screwing in the quick-clamping element. The quick-clamping element is preferably designed as a screw, in particular a grub screw. The quick-clamping element preferably has a clamping surface which is at least intended to fix the centering drill bit at least partially in the receiving region of the centering drill bit when the quick-clamping element is screwed in. The centering drill bit is preferably fixed axially in the receiving region by means of a force-fit connection. The force-fit connection is preferably between the clamping surface of the quick-clamping element and the centering drill bit, in particular a flat surface of a shank of the centering drill bit. Preferably, the quick-clamping element is at least intended to transmit the torque of the machine tool to the centering drill bit. Preferably, the torque of the machine tool is transmitted from the main adapter body to the centering drill bit by means of the quick-clamping element. The torque is preferably transmitted by means of a positive fit between the quick-clamping element and the centering drill bit. Preferably, the quick-clamping unit has a locking element which is intended to fix the centering drill bit axially in the receiving region. The locking element is preferably designed to fix the centering drill bit axially in the receiving region by means of a positive-fit connection. Preferably, the quick-clamping unit has a spring which is intended to press the locking element radially against the centering drill bit. The spring and the locking element are preferably arranged in an opening which is delimited by the quick-clamping element. Preferably, the locking element is designed as a ball. However, other configurations for the locking element are also conceivable, which a person skilled in the art would consider useful and which enable the centering drill bit to be fixed axially in the receiving space of the centering drill bit by means of a positive fit. Preferably, the positive fit between the locking element and the centering drill bit is generated via the locking element and a recess, in particular a locking groove, arranged in the centering drill bit, in particular in the flat surface of the shank of the centering drill bit. Preferably, the centering drill bit is axially fixed by means of the force-fit connection between the clamping surface of the quick-clamping element and the centering drill bit and/or by means of the positive-fit connection between the fixing element and the centering drill bit. It is conceivable that the centering drill bit is only fixed axially by means of the positive-fit connection using the locking element by screwing the quick-clamping element into the main adapter body until the locking element is arranged in the locking groove of the centering drill bit, but the clamping surface is free from contact with the centering drill bit when the machine tool is not in operation. However, it is also conceivable that the quick-clamping element is connected to the main adapter body by means of a joint connection. The joint connection is preferably designed as a press connection, adhesive connection or welded connection. Due to the design of the clamping mandrel adapter device, a centering drill bit, which is free of a hexagonal cross-sectional surface, can be fastened axially and for torque transmission in a receiving region for the centering drill bit. Advantageously, a clamping mandrel adapter device can be provided with a system for quickly changing the centering drill bit. A circular-cylindrical centering drill bit with at least one flat surface, with or without a locking groove, can be driven in an advantageously precisely centered manner. A particularly long cylindrical guide of the centering drill bit by means of a receiving region for the centering drill bit can achieve an advantageously low radial guide clearance. Advantageously, axial and radial guide play can be eliminated by tightening the quick-clamping element, in particular by means of the force-fit connection between the clamping element and the centering drill bit. Furthermore, it is proposed that the clamping mandrel adapter device has at least one rotary clamping unit which is provided for axially fixing and releasing the hole saw, wherein the rotary clamping unit has at least one bushing which is connected, in particular as a single piece, to the main adapter body and which completely encloses at least a part of the hole saw received by the receiving region, and at least one sleeve which is rotatably mounted on the bushing and which is provided for fixing and releasing the hole saw by means of rotation, wherein the bushing is arranged between the sleeve and the main adapter body. The bushing is preferably connected to the main adapter body using a material joining method, in particular a laser welding method. It is conceivable that the bushing is connected to the main adapter body by means of another method which a person skilled in the art would consider useful and which is suitable for connecting the bushing, in particular as a single piece, to the main adapter body, for example by means of an adhesive method and/or a welding method. It is also conceivable that the socket is screwed onto the main adapter body by means of a thread and/or attached by means of a shrink connection. The bushing preferably has a smaller maximum longitudinal extension than the receiving region of the centering drill bit. Preferably, the bushing completely encloses the tool holder in at least one plane perpendicular to the longitudinal extension of the tool holder. Preferably, the bushing and the outer lateral surface of the tool holder form the receiving region for the hole saw. Preferably, the bushing is designed as a hollow cylinder and has an inner lateral surface and an outer lateral surface. Preferably, the receiving region for the hole saw is delimited by the outer lateral surface of the tool holder and the inner lateral surface of the bushing. Preferably, the bushing delimits a space that has a hexagonal cross-sectional area. The bushing is preferably designed to transmit the torque from the machine tool to the hole saw via the main adapter body. Preferably, the bushing transmits the torque of the machine tool by means of a positive-fit connection between the bushing and the hole saw. The positive-fit connection between the bushing and the hole saw is preferably created by the hexagonal design of the cross-sectional area of the space delimited by the bushing. The sleeve preferably has a smaller maximum longitudinal extension than the bushing. Preferably, the sleeve is in the form of a hollow cylinder. Preferably, the bushing extends completely through the sleeve. By the fact that the bushing extends completely through the sleeve, it should be understood that the bushing extends from a first opening of the hollow cylindrical sleeve through the sleeve to a second opening of the hollow cylindrical sleeve. Preferably, the sleeve has the same axis of rotation as the hole saw and/or the centering drill bit. The design of the clamping mandrel adapter device makes it possible to achieve an advantageously precise centering of the hole saw. A robust clamping mandrel adapter device can be advantageously provided.

It is further proposed that the rotary clamping unit for fixing and releasing the hole saw has at least one fixing element, in particular two fixing elements, which fix(es) or release(s) the hole saw depending on one of at least two rotational positions of the sleeve. Preferably, the bushing delimits an opening for each fixing element, which is intended to guide the fixing elements in a radial direction into or out of the receiving space of the hole saw. Preferably, the sleeve delimits a cut-out for each fixing element. The at least one cut-out is preferably intended to at least partially receive the at least one fixing element, which is guided radially out of the receiving space of the hole saw. Preferably, the at least one fixing element is designed as a ball. The rotary clamping unit preferably has two rotational positions for the sleeve. Preferably, a first of the two rotational positions, a fixing position, is provided for fixing the hole saw. Preferably, a second of the two rotational positions, a release position, is provided for releasing the hole saw. Preferably, the sleeve is at least intended to press the at least one fixing element radially into the receiving space of the hole saw in the fixing position. The sleeve is at least intended to provide the at least one fixing element in the release position with a means of withdrawal from the receiving space of the hole saw by means of the at least one cut-out. Preferably, the rotary clamping unit has at least one positioning element. Preferably, the positioning element is designed as a pin. Preferably, the socket delimits at least one plug-in opening. Preferably, the plug-in opening is designed to at least partially receive the positioning element. Preferably, the sleeve has a positioning groove. The positioning element is preferably intended to be arranged at least partially in the positioning groove of the sleeve when the rotary clamping unit is assembled. Preferably, the positioning groove is intended to guide the positioning element between the two rotational positions when the sleeve is rotated. The positioning groove is preferably delimited in a longitudinal direction by two walls of the sleeve. The two walls are preferably intended to form the two rotational positions of the rotary clamping unit. Preferably, the positioning element is arranged in the positioning groove in such a way that the sleeve is guided from one rotational position to the other during rotation between the two walls of the positioning groove. Preferably, the angle of rotation between the two rotational positions is between 20° and 60° and particularly preferably 40°. The design of the clamping mandrel adapter device makes it possible to provide an advantageously robust, structurally simple fixing and release system for a hole saw that comprises few components. An advantageously easy-to-use system for fixing and releasing a hole saw without tools can be provided.

Furthermore, it is proposed that the rotary clamping unit has at least one return spring, which is intended to hold/reset the sleeve in one/one fixing position of the two rotational positions. The return spring is preferably designed as a torsion spring. The return spring preferably has two legs, each of which extends parallel to an axis of rotation of the torsion spring. The two legs preferably extend in opposite directions. Preferably, one of the two legs is arranged in a spring leg holder delimited by the bushing when the rotary clamping unit is assembled. Preferably, a second of the two legs, in the assembled state of the rotary clamping unit, is arranged in a further spring leg holder delimited by the sleeve. The return spring preferably encloses the bushing. The return spring is preferably designed to absorb and store at least part of the torque applied when turning the sleeve. In particular, the sleeve stores the torque that is applied to rotate the sleeve from the fixing position to the release position. The return spring is preferably intended to return the sleeve from the release position to the fixing position by means of the stored torque and to hold it in the release position by means of a spring force of the return spring. Preferably, the return spring is pretensioned to hold the sleeve in the fixing position. The rotary clamping unit is preferably designed in such a way that the sleeve is rotated in one direction from the fixing position to the release position in order to release the hole saw. The direction of rotation for releasing the hole saw is in the direction of view preferably in a clockwise direction from the tool interface to the tool holder. The design of the clamping mandrel adapter device can provide an advantageously secure receiving space for a hole saw. Unintentional loosening of the hole saw can be avoided. The fact that the direction of rotation of the sleeve for release is clockwise, prevents unintentional loosening of the hole saw during operation, in which the direction of rotation is usually clockwise.

It is further proposed that the rotary clamping unit has at least one locking ring and at least one further return spring, wherein the further return spring is intended to press at least one fixing element, in particular the two fixing elements, at least to a large extent out of the receiving region, in particular in the radial direction, by means of the locking ring. The additional return spring is preferably designed as a compression spring. The additional return spring is preferably arranged in the receiving space of the hole saw. Preferably, the additional return spring is arranged in an insertion direction of the hole saw after the locking ring. Preferably, the locking ring is at least intended to transfer an insertion force from the hole saw to the additional return spring when the hole saw is inserted. The insertion force is preferably applied in order to press the hole saw into the receiving space of the additional hole saw against the spring force of the additional return spring. Preferably, the additional return spring is designed to store at least part of the insertion force. The additional return spring is intended to use the stored insertion force to press the at least one fixing element, in particular the two fixing elements, out of the hole saw's receiving space by means of the locking ring. The locking ring is preferably arranged completely in the receiving space of the hole saw. Preferably, the locking ring and the additional return spring enclose the main adapter body. The locking ring is preferably designed as an elastic snap ring. The locking ring preferably has retaining arms. The retaining arms extend inside the locking ring in the direction of an axis of rotation of the locking ring. The retaining arms preferably each have a shoulder that extends radially inwards. The locking ring is preferably made of spring steel sheet or machined spring steel. Preferably, the sleeve is fixed in the release position by the at least one fixing element, in particular the two fixing elements, being pressed radially out of the receiving space of the hole saw, in particular when the receiving space of the hole saw is free of the hole saw. Preferably, the tool holder has at least one region with a reduced outer diameter. The region with the reduced outer diameter is preferably intended to secure the locking ring by means of the retaining arms. Due to the design of the clamping mandrel adapter device, a hole saw can be received and released from the tool holder in a simple and user-friendly manner.

Furthermore, it is proposed that the bushing has a radially outwardly projecting, peripherally extending protective shoulder, which is arranged on a side of the main adapter body facing away from the tool interface and is intended to protect the sleeve in the axial direction from external impact, in particular during operation of a machine tool. Preferably, the spring leg holder, which is delimited by the bushing, is arranged in the protective shoulder of the bushing. Due to the design of the clamping mandrel adapter device, the sleeve can be advantageously protected against external influences from the axial direction. Unintentional release of the hole saw can be prevented. The clamping mandrel adapter can be advantageously protected against external influences from the axial direction. An advantageously simple and cost-effective clamping mandrel adapter device with sufficient protection can be provided.

Furthermore, an assembly method for assembling the clamping mandrel adapter device is proposed. In a method step, the additional return spring is pushed onto the main adapter body in the receiving space of the hole saw. Preferably, the locking ring is pushed onto the main adapter body in the receiving space of the hole saw in one method step. The locking ring is preferably pushed onto the main adapter body after the other return spring. Preferably, the retaining arms deform elastically radially outwards when the locking ring is pushed on to enable it to be pushed on. Preferably, the locking ring is pushed into the receiving region of the hole saw until it is arranged in the region of the tool holder with a reduced outer diameter. Preferably, the retaining arms spring back elastically into their original shape when they have reached the region with the reduced outer diameter. In this context, an “original shape of the retaining arms” is to be understood in particular as a stress-free state of the locking ring, in particular of the retaining arms. The design of the assembly method according to the invention allows a clamping mandrel adapter device to be assembled advantageously, cost-effectively and without the need for further work steps or work parts.

Furthermore, a machine tool system with a machine tool and with the clamping mandrel adapter device is proposed. The machine tool is preferably designed as a drilling machine or a hand drill. In particular, the machine tool can have a housing, a handle, a power supply unit, such as an accumulator, a battery, a mains supply or the like, a drive unit, an output unit and/or other components which appear useful to a person skilled in the art. Advantageously, a user-friendly and user-safe clamping mandrel adapter device can be provided.

The clamping mandrel adapter device according to the invention, the assembly method according to the invention for assembling the clamping mandrel adapter device and the machine tool according to the invention having the clamping mandrel adapter device should not be limited to the application and embodiment described above. In particular, the clamping mandrel adapter device according to the invention, the assembly method according to the invention for assembling the clamping mandrel adapter device and the machine tool according to the invention with the clamping mandrel adapter device can have a number of individual elements, components and units as well as method steps that deviates from a number specified herein in order to fulfill a mode of operation described herein. Moreover, regarding the ranges of values indicated in this disclosure, values lying within the limits specified hereinabove are also intended to be considered as disclosed and usable as desired.

### DRAWINGS

Further advantages emerge from the description of the drawings hereinafter. An exemplary embodiment of the invention is shown in the drawing. The drawings, the description, and the claims contain numerous features in combination. A person skilled in the art will appropriately also consider the features individually and combine them into additional advantageous combinations.

Shown are:

FIG. 1 a machine tool system according to the invention with a machine tool and a clamping mandrel adapter device according to the invention in a schematic representation,

FIG. 2 The clamping mandrel adapter device with a centering drill bit and a hole saw in a schematic sectional view,

FIG. 3 a part of the clamping mandrel adapter device according to the invention in a schematic sectional view,

FIG. 4 The clamping mandrel adapter device according to the invention with a rotary clamping unit in a release position in a schematic sectional view,

FIG. 5 The clamping mandrel adapter device according to the invention with a rotary clamping unit in a fixing position in a schematic sectional view,

FIG. 6 The clamping mandrel adapter device according to the invention in a schematic exploded view,

FIG. 7 A schematic representation of a part of the clamping mandrel adapter device according to the invention,

FIG. 8 a part of the clamping mandrel adapter device according to the invention in a schematic sectional view and

FIG. 9 A schematic representation of an assembly method according to the invention

### DESCRIPTION OF THE EXEMPLARY EMBODIMENT

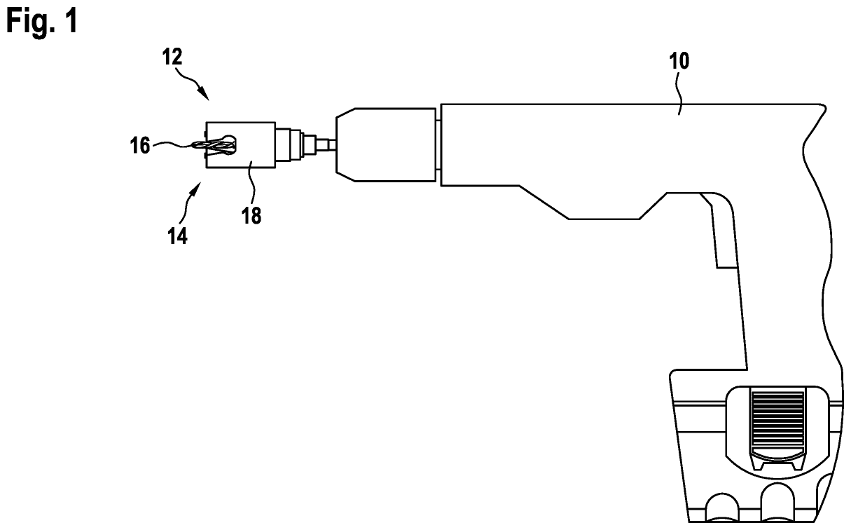

FIG. 1 shows a machine tool system with a machine tool 10 and a clamping mandrel adapter device 12. The machine tool 10 is designed as a hand drill. The machine tool 10 has a housing, a handle, a power supply unit, in particular an accumulator, and a drive unit.

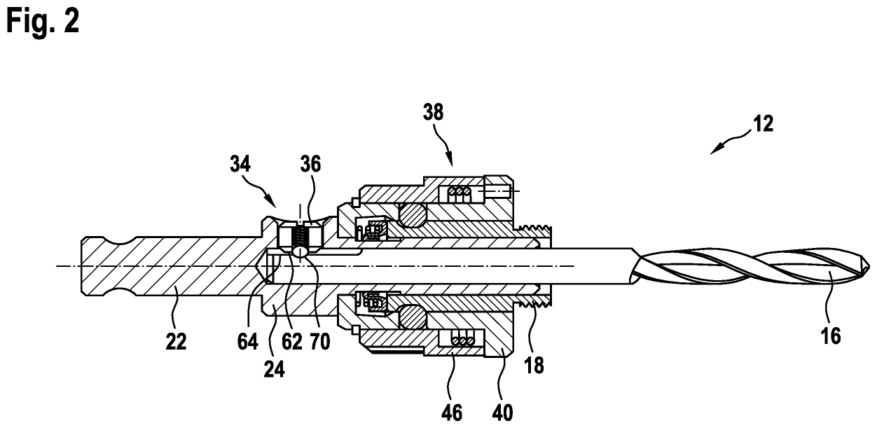

FIG. 2 shows the clamping mandrel adapter device 12 for assembling a hole saw unit 14, which comprises at least a centering drill bit 16 and a hole saw 18, on the machine tool 10. The clamping mandrel adapter device 12 has a main adapter body 20, which comprises a hexagonal tool interface 22 for assembling on the machine tool 10 and a tool holder 24 for receiving the hole saw unit 14. The clamping mandrel adapter device 12 has a circular-cylindrical receiving region 26 for the centering drill bit 16 and a hollow cylindrical receiving region 28 for the hole saw 18. The tool holder 24 is in the form of a hollow cylinder, with an inner lateral surface 30 and an outer lateral surface 32. The tool holder 24 partially delimits the one circular-cylindrical receiving region 26 for the centering drill bit 16 with the inner lateral surface 30, as well as the hollow cylindrical receiving region 28 for the hole saw 18 with the outer lateral surface 32. In an assembled state of the hole saw unit 14, the centering drill bit 16 is arranged in a space delimited by the hole saw 18. The main adapter body 20 is designed to receive the hole saw unit 14 and connect it to the machine tool 10. The main adapter body 20 is designed to transmit a rotational movement of the machine tool 10 to the hole saw unit 14. The main adapter body 20 forms the tool interface 22 and the tool holder 24. The tool interface 22 is intended to be received by the machine tool 10. The tool interface 22 is made from a solid material. The tool interface 22 has a groove 56 running completely around the tool interface 22. The groove 56 of the tool interface 22 is provided for a quick-change system between the clamping mandrel adapter device 12 and the machine tool 10. A torque, which is intended to drive the hole saw unit 14, is transmitted from the machine tool 10 to the main adapter body 20 by means of a positive-fit connection through the hexagonal cross-section of the tool interface 22. The receiving region 26 for the centering drill bit 16 has an opening 42 for inserting the centering drill bit 16. The opening 42 for the centering drill bit 16 is arranged on a side of the main adapter body 20 facing away from the tool interface 22. The tool holder 24 is designed in such a way that the hole saw 18 and the centering drill bit 16 have the same axis of rotation when assembled. The tool holder 24, in particular the entire main adapter body 20, is a single piece. The tool holder 24 and the tool interface 22 are connected as a single piece.

The clamping mandrel adapter device 12 has a quick-clamping unit 34 with at least one quick-clamping element 36. The quick-clamping element 36 forms a thread for screwing into the main adapter body 20, wherein the quick-clamping unit 34 is provided for fixing and releasing the centering drill bit 16 at least axially in the receiving region 26 of the centering drill bit 16. The main adapter body 20 has a bore 60 with a thread for screwing in the quick-clamping element 36. The bore 60 leads from the outside of an main adapter body into the receiving region 26 for the centering drill bit 16. The quick-clamping element 36 is designed as a screw. The quick-clamping element 36 has a clamping surface 62, which is intended to fix the centering drill bit 16 axially in the receiving region 26 of the centering drill bit 16 when the quick-clamping element 36 is screwed in. The centering drill bit 16 is fixed axially in the receiving region 26 by means of a force-fit connection. The force-fit connection exists between the clamping surface 62 of the quick-clamping element 36 and the centering drill bit 16, in particular a flat surface 64 of a shank of the centering drill bit 16. The quick-clamping element 36 is intended to transmit the torque of the machine tool 10 to the centering drill bit 16. The torque of the machine tool 10 is transmitted from the main adapter body 20 to the centering drill bit 16 by means of the quick-clamping element 36. The torque is transmitted by means of a positive fit between the quick-clamping element 36 and the centering drill bit 16. The quick-clamping unit 34 has a locking element 58, which is intended to fix the centering drill bit 16 axially in the receiving region 26. The locking element 58 is intended to fix the centering drill bit 16 axially in the receiving region 26 by means of a positive-fit connection. The quick-clamping unit 34 has a spring 68, which is intended to press the locking element 58 radially against the centering drill bit 16. The spring 68 and the locking element 58 are arranged in an opening 66, which is delimited by the quick-clamping element 36. The locking element 58 is designed as a ball. However, other configurations for the locking element 58 are also conceivable which would appear to a skilled person to be useful and which enable the centering drill bit 16 to be fixed axially in the receiving space 26 of the centering drill bit 16 by means of its positive fit. The positive fit between the locking element 58 and the centering drill bit 16 is established via the locking element 58 and a locking groove 70 arranged in the centering drill bit 16, in particular in the flat surface 64 of the shank of the centering drill bit 16. The centering drill bit 16 is axially fixed by means of the force-fit connection between the clamping surface 62 of the quick-clamping element 36 and the centering drill bit 16 and/or by means of the positive-fit connection between the locking element 58 and the centering drill bit 16. It is conceivable that the centering drill bit 16 is only axially fixed by means of the positive-fit connection by means of the locking element 58, in that the quick-clamping element 36 is only screwed into the main adapter body 20 until the locking element 58 is arranged in the locking groove 70 of the centering drill bit 16, but the clamping surface 62, when the machine tool 10 is not in operation, is free from contact with the centering drill bit 16, in particular the flat surface 64 (FIG. 8).

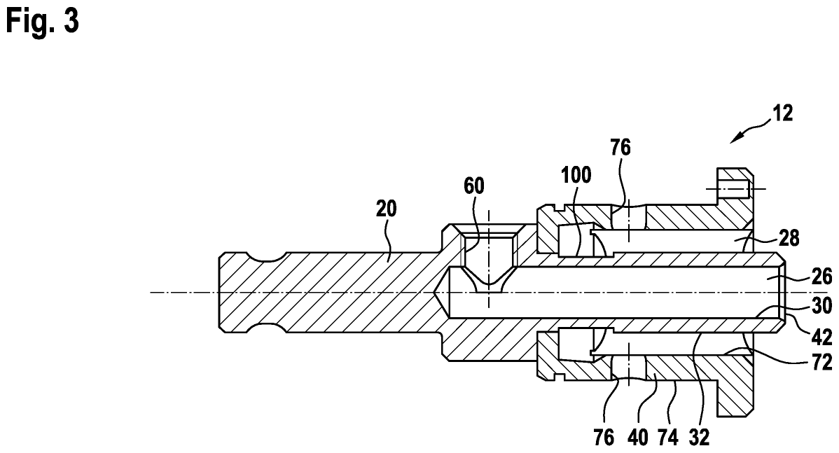

The clamping mandrel adapter device 12 has a rotary clamping unit 38, which is intended to axially fix and release the hole saw 18. The rotary clamping unit 38 comprises a bushing 40, in particular connected as a single piece to the main adapter body 20, which completely encloses a part of the hole saw 18 received by the receiving region 28, and a sleeve 46, which is rotatably mounted on the bushing 40 and is intended to enable the hole saw 18 to be fixed and released by means of rotation. FIG. 3 shows the main adapter body 20 with the bushing 40 connected as a single piece to the main adapter body. The bushing 40 is arranged between the sleeve 46 and the main adapter body 20. The bushing 40 is connected to the main adapter body 20 using a laser welding method. It is conceivable that the bushing 40 is connected to the main adapter body 20 by means of another method which appears to a person skilled in the art to be useful and which is suitable for connecting the bushing 40, in particular as a single piece, to the main adapter body 20, for example by means of an adhesive method and/or a welding method. It is also conceivable that the bushing 40 is screwed onto the main adapter body 20 by means of a thread and/or attached by means of a shrink connection. The bushing 40 has a smaller maximum longitudinal extension than the receiving region 26 of the centering dill bit 16. The bushing 40 completely encloses the tool holder 24 in a plane perpendicular to the longitudinal extension of the tool holder 24. The bushing 40 and the outer lateral surface 32 of the tool holder 24 form the receiving region 28 for the hole saw 18. The bushing 40 is designed as a hollow cylinder and has an inner lateral surface 72 and an outer lateral surface 74. The receiving region 28 for the hole saw 18 is delimited by the outer lateral surface 32 of the tool holder 24 and the inner lateral surface 72 of the bushing. The bushing 40 delimits a space that has a hexagonal cross-sectional area. The bushing 40 is intended to transmit the torque from the machine tool 10 to the hole saw 18 via the main adapter body 20. The bushing 40 transmits the torque of the machine tool 10 by means of a positive-fit connection between the bushing 40 and the hole saw 18. The positive-fit connection between the bushing 40 and the hole saw 18 is created by the hexagonal design of the cross-sectional area of the space delimited by the bushing 40. The inner lateral surface 72 of the bushing and a part of the outer lateral surface of the sleeve, which is received by the receiving region 28, are each hexagonal in order to produce the positive-fit connection. The sleeve 46 has a smaller maximum longitudinal extension than the bushing 40. The sleeve 46 is in the form of a hollow cylinder. The bushing 40 extends completely through the sleeve 46. The sleeve 46 has the same axis of rotation as the hole saw 18 and/or the centering drill bit 16 (FIG. 3).

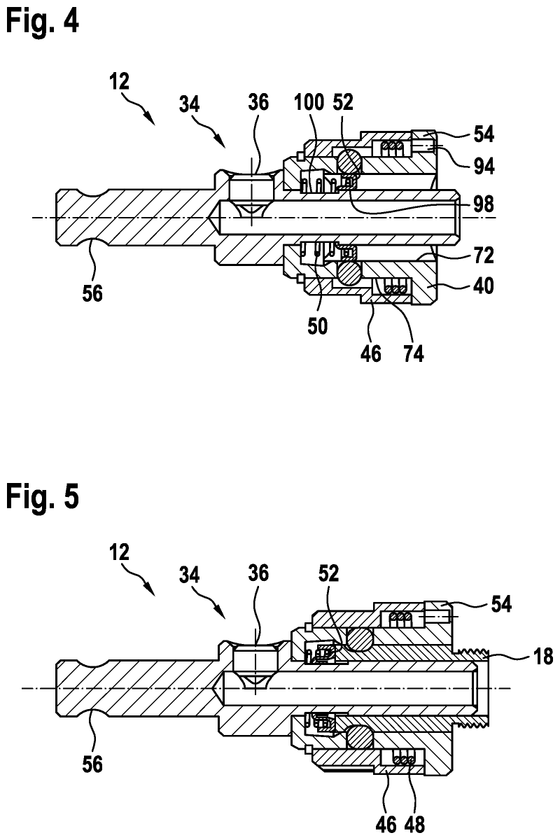

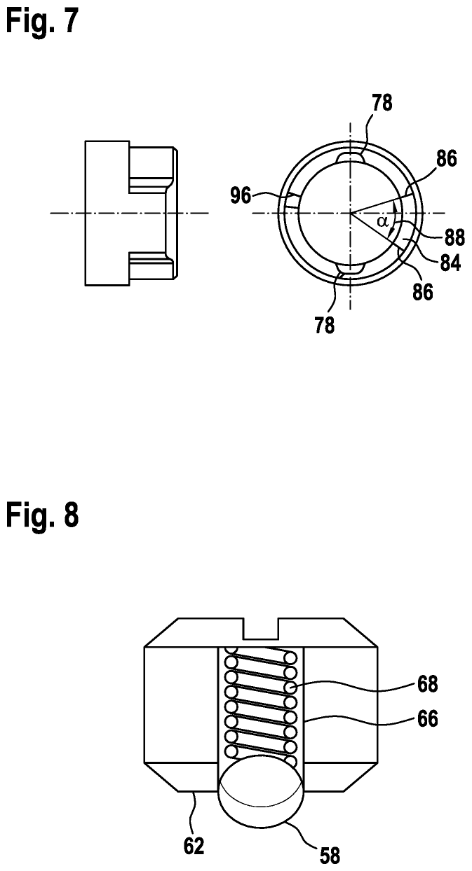

The rotary clamping unit 38 has two fixing elements 44 for fixing and releasing the hole saw 18, which fix or release the hole saw 18 depending on one of at least two rotational positions of the sleeve 46. The bushing 40 delimits an opening 76 for each fixing element 44, which is intended to guide the fixing elements 44 in a radial direction into or out of the receiving space 28 of the hole saw 18. The sleeve 46 delimits a cut-out 78 for each fixing element 44. The two cut-outs 78 are preferably intended to partially receive the two fixing elements 44, which are guided radially out of the receiving space 28 of the hole saw 18. The two fixing elements 44 are each designed as a ball. The rotary clamping unit 38 has two rotational positions for the sleeve 46. A first of the two rotational positions is a fixing position for fixing the hole saw 18. The first rotational position, the fixing position, is shown in FIG. 5. A second of the two rotational positions is a release position for releasing the hole saw 18. The second rotational position, the release position, is shown in FIG. 4. The sleeve 46 is intended to press the two fixing elements 44 radially into the receiving space 28 of the hole saw 18 in the fixing position of the rotary clamping unit 38. The sleeve 46 is intended to provide the two fixing elements 44 in the release position with a means of withdrawal from the receiving space 28 of the hole saw 18 by means of the two cut-outs 78. The rotary clamping unit has a retaining ring 102. The retaining ring 102 is intended to axially fix the sleeve. The retaining ring 102 is arranged in front of the sleeve in the direction of view from the tool interface 22 to the tool holder 24. The bushing 40 has a groove which is intended to receive the retaining ring 102. The rotary clamping unit 38 has a positioning element 80. The positioning element 80 is designed as a pin. The bushing 40 delimits a plug-in opening 82. The plug-in opening 82 is intended to at least partially receive the positioning element 80. The sleeve 46 has a positioning groove 84. The positioning element 80 is intended to be arranged in the positioning groove 84 of the sleeve 46 when the rotary clamping unit 38 is assembled. The positioning element 80 is intended to be guided by the positioning groove 84 when the sleeve 46 is rotated. The positioning groove 84 is delimited in a longitudinal direction by two walls 86 of the sleeve 46. The two walls 86 are intended to stop the positioning element 80 in the two rotational positions. The positioning element 80 is arranged in the positioning groove 84 in such a way that the sleeve 46 is guided from one rotational position to the other during rotation between the two walls 86 of the positioning groove 84. A rotation angle 88 between the two rotational positions is 47° (FIG. 7).

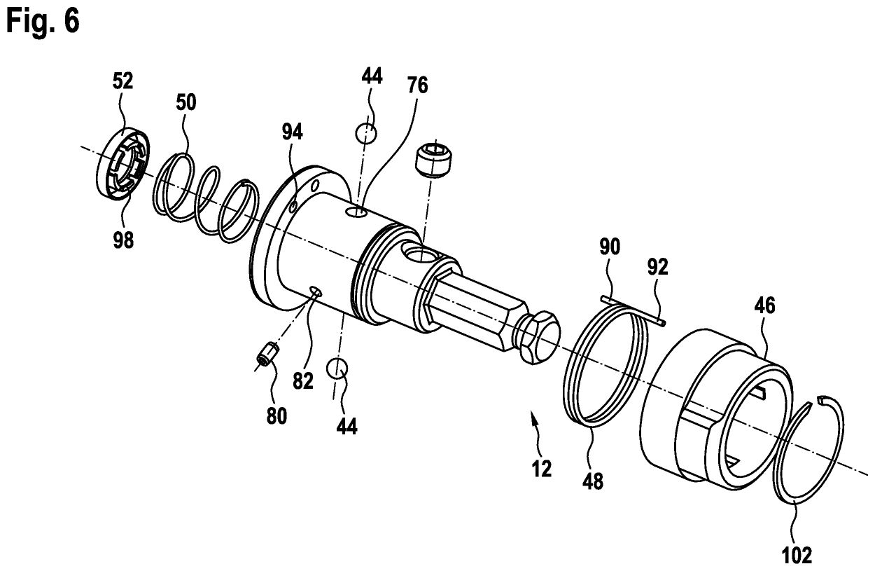

The rotary clamping unit 38 has a return spring 48, which is intended to hold/reset the sleeve 46 in one/fixing position of the two rotational positions. The return spring 48 is designed as a torsion spring. The return spring 48 has two legs 90, 92, which each extend parallel to an axis of rotation of the torsion spring. The two legs 90, 92 extend in opposite directions. One of the two legs 90 is arranged in a spring leg holder 94 delimited by the bushing 40 when the rotary clamping unit 38 is assembled. A second of the two legs 92 is arranged in a further spring leg holder 96 delimited by the sleeve 46 when the rotary clamping unit 38 is assembled. The return spring 48 completely encloses the bushing 40 in a plane perpendicular to the axis of rotation of the bushing 40. The return spring 48 is intended to partially absorb and store a torque applied when the sleeve 46 is turned. The sleeve 46 stores the torque that is applied to rotate the sleeve 46 from the fixing position to the release position. The return spring 48 is intended to return the sleeve 46 from the release position to the fixing position by means of the stored torque and/or with the torque from a preload of the return spring 48 and to hold it in the release position by means of a spring force and/or the preload of the return spring 48. The return spring 48 is pretensioned to hold the sleeve 46 in the fixing position. The rotary clamping unit 38 is designed in such a way that the sleeve 46 is rotated in one direction from the fixing position to the release position in order to release the hole saw 18. The direction of rotation for releasing the hole saw 18 is formed in the direction of view in a clockwise direction from the tool interface 22 to the tool holder 24 (FIG. 6).

FIGS. 4 and 5 show the clamping mandrel adapter device 12 in the two rotational positions. In FIG. 5, the hole saw 18 is arranged in the receiving space 28. FIG. 4 shows the clamping mandrel adapter device 12 free of the hole saw 18 and the centering drill bit 16. The rotary clamping unit 38 has a locking ring 52 and a further return spring 50, wherein the further return spring 50 is intended to press the two fixing elements 44 to a large extent out of the receiving region 28 in the radial direction by means of the locking ring 52. The other return spring 50 is designed as a compression spring. The other return spring 50 is arranged in the receiving space 28 of the hole saw 18. The further return spring 50 is arranged in an insertion direction of the hole saw 18 after the locking ring 52. The locking ring 52 is intended to transfer an insertion force from the hole saw 18 to the additional return spring 50 when the hole saw 18 is inserted. The insertion force is applied in order to press the hole saw 18 into the receiving space 28 of the additional hole saw 18 against a spring force of the additional return spring 50. The additional return spring 50 is designed to store at least part of the insertion force. The further return spring 50 is intended to use the stored insertion force to press the two fixing elements 44 out of the receiving space 28 of the hole saw 18 by means of the locking ring 52. The locking ring 52 is arranged completely in the receiving space 28 of the hole saw 18. The locking ring 52 and the further return spring 50 completely enclose the main adapter body 20 in at least one plane perpendicular to the axis of rotation of the main adapter body 20. The locking ring 52 is designed as an elastic snap ring. The locking ring 52 has retaining arms 98, which extend inside the locking ring 52 in the direction of an axis of rotation of the locking ring 52. The sleeve 46 is fixed in the release position by the two fixing elements 44 being pressed radially out of the receiving space 28 of the hole saw 18, in particular when the receiving space 28 of the hole saw 18 is free of the hole saw 18. The tool holder 24 has a region 100 with a reduced outer diameter. The region 100 with the reduced outer diameter is intended to secure the locking ring 52 by means of the retaining arms 98 (FIGS. 4 and 5).

The bushing 40 has a radially outwardly projecting, peripherally extending protective shoulder 54, which is arranged on a side of the main adapter body 20 facing away from the tool interface 22 and is intended to protect the sleeve 46 in the axial direction from an external influence, in particular during operation of a machine tool 10. The spring leg holder 94, which is delimited by the bushing 40, is arranged in the protective shoulder 54 of the bushing 40 (FIG. 2). As can be seen in FIG. 5, the sleeve 46 is arranged between the retaining ring 102 and the protective shoulder 54.

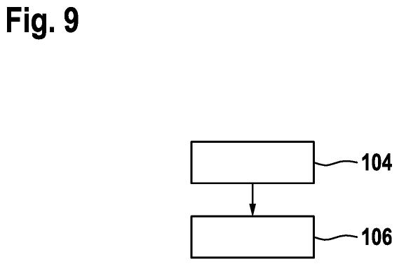

An assembly method for assembling the clamping mandrel adapter device 12 is described below with reference to FIGS. 6 and 9. In an assembly step 104, the further return spring 50 is pushed onto the main adapter body 20, into the receiving space 28 of the hole saw 18. In a further assembly step 106, the locking ring 52 is pushed onto the main adapter body 20, into the receiving space 28 of the hole saw 18. The locking ring 52 is pushed onto the main adapter body 20 in the next assembly step 106 after the other return spring 50. When the locking ring 52 is pushed on in the further assembly step 106, the retaining arms 98 deform elastically radially outwards in order to enable it to be pushed on. In the further assembly step 106, the locking ring 52 is pushed into the receiving region 28 of the hole saw 18 until it is arranged in the region 100 of the tool holder 24 with a reduced outer diameter. When the retaining arms 98 reach the region 100 with the reduced outer diameter, they elastically spring back into their original shape.

1. A clamping mandrel adapter device for assembling a hole saw unit on a machine tool the hole saw unit including at least one centering drill bit and a hole saw, the clamping mandrel adapter device, comprising:
at least one main adapter body including at least one tool interface for assembling on the machine tool and at least one tool holder configured to receive the hole saw unit;
at least one circular-cylindrical, receiving region configured to receive the at least one centering drill bit; and
a hollow cylindrical receiving region configured to receive the hole saw,
wherein the at least one tool holder includes a hollow cylinder with an inner lateral surface and an outer lateral surface, and the at least one tool holder delimits the at least one circular-cylindrical receiving region with the inner lateral surface, and at least partially delimits the hollow cylindrical receiving region with the outer lateral surface, and
wherein the entire at least one main adapter body is a single piece.

2. The clamping mandrel adapter device according to claim 1, further comprising:
a quick-clamping unit including at least one quick-clamping element arranged in a bore of the at least one main adapter body,
wherein the quick-clamping unit is configured to fix and to release the at least one centering drill bit at least axially in the circular-cylindrical receiving region of the at least one centering drill bit.

3. The clamping mandrel adapter device according to claim 1, further comprising:
at least one rotary clamping unit configured to axially fix and release the hole saw,
wherein the at least one rotary clamping unit comprises (i) at least one bushing connected as a single piece to the at least one main adapter body, the at least one bushing completely enclosing at least a part of the hole saw received by the hollow cylindrical receiving region, and (ii) at least one sleeve rotatably mounted on the at least one bushing and configured to enable the hole saw to be fixed and released by rotation, and
wherein the at least one bushing is disposed between the at least one sleeve and the at least one main adapter body.

4. The clamping mandrel device according to claim 3, wherein the at least one rotary clamping unit has at least one fixing element configured to fix or to release the hole saw depending on one of at least two rotational positions of the at least one sleeve.

5. The clamping mandrel adapter device according to claim 4, wherein the at least one rotary clamping unit has at least one return spring configured to hold and/or to reset the at least one sleeve in a fixing position of the at least two rotational positions.

6. The clamping mandrel adapter device according to claim 5, wherein:
the at least one rotary clamping unit has at least one locking ring and at least one further return spring, and
the at least one further return spring is configured to press the at least one fixing element by the at least one locking ring out of the hollow cylindrical receiving region in a radial direction.

7. The clamping mandrel adapter device according to claim 3, wherein the at least one bushing has a radially outwardly projecting, peripherally extending protective shoulder arranged on a side of the at least one main adapter body facing away from the at least one tool interface and intended to protect the at least one sleeve in an axial direction from an external influence, during operation of the machine tool.

8. An assembly method for assembling a clamping mandrel adapter device according to claim 1.

9. A machine tool system with a machine tool and with a clamping mandrel adapter device according to claim 1.
